(19) United States
(12) Patent Application Publication
(10) Pub. No.: US 2025/0203050 A1
(43) Pub. Date: Jun. 19, 2025

(54) VEHICULAR VIDEO DISPLAY APPARATUS

(71) Applicant: Honda Motor Co., Ltd., Tokyo (JP)

(72) Inventors: Yoshikazu Matsuo, Tokyo (JP); Tatsumi Suzuki, Saitama (JP); Ryotaro Nishida, Saitama (JP); Takafumi Enomoto, Tokyo (JP); Koya Saito, Tokyo (JP); Kenji Okuma, Tokyo (JP)

(21) Appl. No.: 18/973,075

(22) Filed: Dec. 8, 2024

(30) Foreign Application Priority Data
Dec. 14, 2023 (JP) 2023-211075

(51) Int. Cl. H04N 9/31; B60N 2/20

(52) U.S. Cl. CPC H04N 9/3188; B60N 2/20

(57) ABSTRACT

A vehicular video display apparatus, includes: a display unit mounted on a vehicle and configured to display a video content, and a controller including a processor and a memory coupled to the processor. The controller is configured to: acquire video information regarding the video content, and control the display unit to adjust a display size of the video content based on the video information.

### CROSS-REFERENCE TO RELATED APPLICATION

This application is based upon and claims the benefit of priority from Japanese Patent Application No. 2023-211075 filed on Dec. 14, 2023, the content of which is incorporated herein by reference.

### BACKGROUND OF THE INVENTION

### Field of the Invention

The present invention relates to a vehicular video display apparatus that displays a video content in a vehicle.

### Description of the Related Art

As this type of device, a device configured to project a video from a projector onto a wall surface of a vehicle has been conventionally known. For example, in the device described in JP2022-174048 A, the projection angle of the video by the projector is adjusted in accordance with a tilt angle of a rear seat on which an occupant viewing the video is seated.

These years, by the way, the need to enjoy a video content on a large screen in a vehicle is increasing. However, when viewing the video content on a large screen in a limited space inside the vehicle, the occupant is prone to suffer from visually induced motion sickness.

### SUMMARY OF THE INVENTION

An aspect of the present invention is a vehicular video display apparatus, including: a display unit mounted on a vehicle and configured to display a video content; and a controller including a processor and a memory coupled to the processor. The controller is configured to: acquire video information regarding the video content; and control the display unit to adjust a display size of the video content based on the video information.

### BRIEF DESCRIPTION OF THE DRAWINGS

The objects, features, and advantages of the present invention will become clearer from the following description of embodiments in relation to the attached drawings, in which:

FIG. 1 is a schematic diagram illustrating a state in which an occupant of a vehicle, on which a vehicular video display apparatus according to an embodiment of the present invention is mounted, views a video content, and the vehicle is partially cut away;

FIG. 2 is a block diagram schematically illustrating a configuration of main components of the vehicular video display apparatus according to the embodiment of the present invention;

FIG. 3 is a diagram for describing an example of display size adjustment of the video content in accordance with the type of the video content;

FIG. 4 is a diagram for describing an example of display size adjustment of the video content in accordance with the number of playbacks of the video content; and

FIG. 5 is a flowchart illustrating an example of processing performed by a controller in FIG. 2.

### DETAILED DESCRIPTION OF THE INVENTION

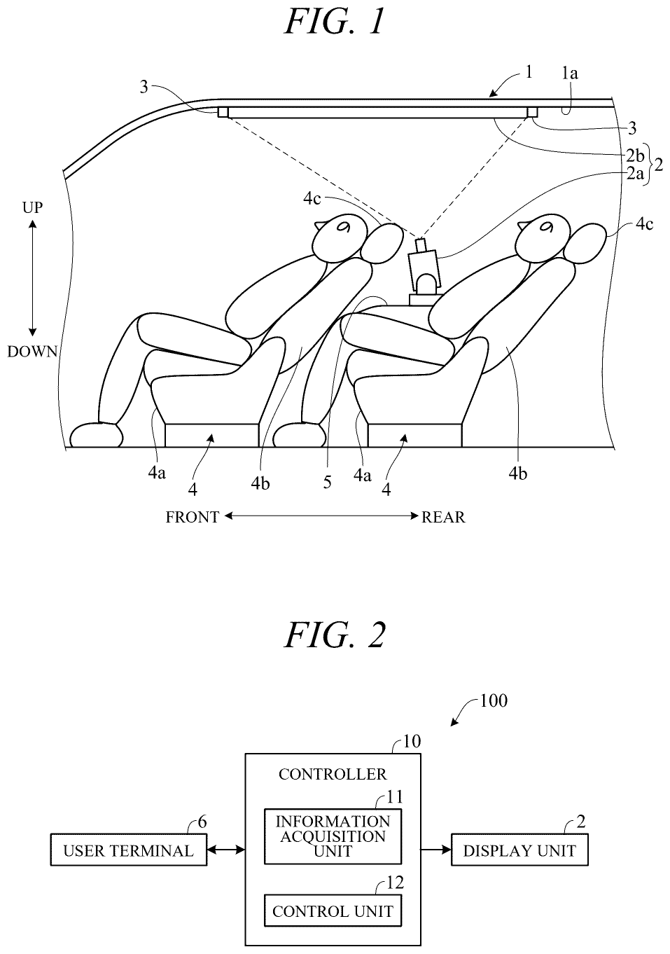

Hereinafter, embodiments of the present invention will be described with reference to FIGS. 1 to 5. These years, the need to enjoy a video content on a large screen in a vehicle is increasing. However, when viewing the video content on a large screen in a limited space inside the vehicle, the occupant is prone to suffer from visually induced motion sickness. That is, in general, an optimum distance (an optimum viewing distance) from a viewer to the screen is considered to be about three times the height of the screen. However, when viewing a video content on a large screen in a limited space inside the vehicle, it is difficult to ensure the optimum viewing distance. Therefore, in the present embodiment, the vehicular video display apparatus is configured as follows so that it becomes possible to suppress visually induced motion sickness of an occupant, even when viewing the video content on the large screen in the limited space inside the vehicle.

FIG. 1 is a schematic diagram illustrating a state in which an occupant of a vehicle 1, on which a vehicular video display apparatus according to an embodiment of the present invention is mounted, views a video content, and the vehicle 1 is partially cut away. Note that in the following, for convenience of description, a front-rear direction and an up-down direction as illustrated are defined, and the configuration of each part will be described in accordance with such definitions. As illustrated in FIG. 1, the vehicle 1 is a vehicle having two rows including front seats located on the front side of the vehicle and rear seats located behind the front seats, and the front seats include a driver's seat and a passenger's seat. Note that FIG. 1 illustrates one front seat (the driver's seat or the passenger's seat) for convenience of description.

A display unit 2, which is capable of displaying a video content on a large screen, is provided in the vehicle 1. In the example of FIG. 1, the display unit 2 is configured as a projector system including a projector 2a and a screen 2b. The projector 2a includes a pan-tilt mechanism and a zoom mechanism, and is configured to be capable of changing a projection range. The screen 2b is attached to any place in the vehicle, for example, a ceiling 1a of the vehicle 1, with use of a fixture 3 such as a clip. In a case where the screen 2b is attached to the ceiling 1a of the vehicle 1, a wide projection range is kept, and it is possible to view the video content on a large screen. Note that the display unit 2 may be configured as a liquid crystal display or the like attached to an instrument panel, a back surface of the front seat, the ceiling, or the like, or may be configured as an aerial display that forms an image in midair in a space inside the vehicle.

A seat 4 of each seat of the vehicle 1 includes a seat cushion portion 4a, which supports the buttocks of the occupant, a seat back portion 4b, which supports the back of the occupant, and a headrest portion 4c, which is provided on the seat back portion 4b, and which supports the head of the occupant. The seat cushion portion 4a includes a front-rear position adjustment mechanism that is slidable in the front-rear direction and that is fixable at any position. The seat back portion 4b has a reclining mechanism capable of fixing an inclination angle with respect to the seat cushion portion 4a at any angle. The headrest portion 4c has an up-down position adjustment mechanism that is movable upward from an upper end portion of the seat back portion 4b and that is fixable at a predetermined position.

A center console 5 is provided between the two left and right seats 4 of the front seats and the rear seats. The projector 2a can be disposed at any place in the vehicle. In a case where the screen 2b is attached to the ceiling 1a of the vehicle 1, it is possible to dispose the projector 2a, for example, on the center console 5 to project the video content in a direction of the screen 2b, that is, toward a space above the occupants. Note that FIG. 1 illustrates only the center console (a rear center console) 5, which is provided between the rear seats, and illustrates an example in which the projector 2a is disposed on the rear center console 5.

The arrangements of the projector 2a and the screen 2b are determined, and then it is possible to make an initial setting of the projection range with use of the pan-tilt mechanism and the zoom mechanism of the projector 2a. The initial setting is made in such a manner that the projection range is suitable for each occupant to view a test still image in a state in which all the seats 4 are reclined, while the vehicle 1 is stopped. In the initial setting, in addition to the projection range in the case of displaying a single large screen to be viewed by all the occupants (full screen display), it is possible to set the projection range in the case of displaying a plurality of screens at positions corresponding to the respective seats (multiple display).

FIG. 2 is a block diagram schematically illustrating a configuration of main components of the vehicular video display apparatus (hereinafter, the apparatus) 100 according to the embodiment of the present invention. As illustrated in FIG. 2, the apparatus 100 includes the display unit 2 (the projector 2a), a controller 10, which controls the display unit 2, and a user terminal 6, which is capable of outputting a video content. The controller 10 is connected with each the display unit 2 (the projector 2a) and the user terminal 6 in a wired or wireless manner.

As the user terminal 6, which is capable of outputting the video content, for example, a portable device such as a smartphone, a portable game machine, or a video camera carried by an occupant can be used. An entertainment system mounted on the vehicle 1 can also be used as the user terminal 6. The user terminal 6 outputs, to the projector 2a via the controller 10, a video signal corresponding to the video content that has been selected in response to an operation by an occupant who is a user.

The user terminal 6 may transmit (output), to the controller 10, a video file corresponding to the video content that has been selected in response to the operation by the occupant. The video file that has been transmitted from the user terminal 6 to the controller 10 is stored in a memory of the controller 10. A moving image file and an image file are stored beforehand in the memory of the controller 10. The video file that has been transmitted from the user terminal 6 to the controller 10 may be stored together with a file stored beforehand in the memory of the controller 10, or may be stored after the file stored beforehand is erased.

When outputting the video signal or the video file corresponding to the video content, the user terminal 6 transmits video information about the video content to the controller 10. The video information includes information about the type of the video content and information about the number of playbacks of the video content. The information about the type of the video content is information about whether the video content is a game, a moving image other than the game, or a still image. In a case where the video content is a game, the number of playbacks of the video content is the number of times of playing the game, and in a case where the video content is a still image, the number of playbacks of the video content is the number of times of browsing the still image. The number of playbacks of the video content is counted as, for example, the number of playbacks of the identical video content after the user terminal 6 and the controller 10 are connected with each other when in a vehicle this time.

The controller 10 is configured with a computer including a processor such as a CPU, a memory such as a ROM and a RAM, and other peripheral circuits, and is incorporated in, for example, the projector 2a. The controller 10 may be configured with an independent computer that is not incorporated in the projector 2a, or a user terminal such as a smartphone carried by an occupant may be used as the controller 10. By executing a program stored beforehand in the memory, the processor of the controller 10 functions as an information acquisition unit 11 and a control unit 12.

The information acquisition unit 11 acquires the video information that has been transmitted from the user terminal 6. The control unit 12 transmits the video signal to the display unit 2, controls the display unit 2 to display the video content, and also controls the display unit 2 to adjust the display size of the video content, based on the video information that has been acquired by the information acquisition unit 11. More specifically, in a case where the display unit 2 is a projector system, the size of the projection range initially set while the vehicle 1 is stopped is set to a display size of 100%, and the control unit 12 controls the display unit 2 (the projector 2a) in accordance with the video information. In a case where the display unit 2 is a display, the size of the entire display is set to a display size of 100%, and the control unit 12 controls the display unit 2 in accordance with the video information.

When a deviation occurs between motion information (information about the magnitude of a moving speed and a direction and the magnitude of acceleration) that enters the viewer's eyes and motion information sensed by the body such as inner ears, muscles, and joints, the brain is confused and the autonomic nerve is disturbed. The visually induced motion sickness occurs accordingly. Therefore, when the occupant of the vehicle 1 views the video content, as the video content necessitates more viewpoint movements of the viewer (occupant), the deviation more easily occurs between the information of the motions that enters the eyes and the information of the motion sensed by the body, and the occupant is more easily prone to suffer from the visually induced motion sickness.

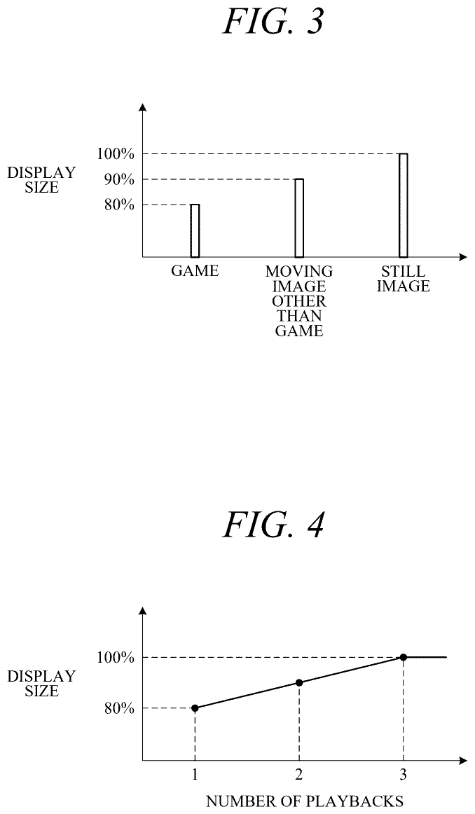

FIGS. 3 and 4 are diagrams for describing the adjustment of the display size of the video content by the control unit 12. FIG. 3 illustrates an adjustment example of the display size in accordance with the type of the video content, and FIG. 4 illustrates an adjustment example of the display size in accordance with the number of playbacks of the video content.

As illustrated in FIG. 3, in a case where the video content is a game that particularly necessitates viewpoint movements of the viewer (occupant), the control unit 12 controls the display unit 2 so that the display size is 80%, for example. In a case where the video content is a moving image other than the game that necessitates many viewpoint movements, although such movements are not as many as the game, the control unit 12 controls the display unit 2 so that the display size is 90%, for example. In a case where the video content is a still image that scarcely necessitates the viewpoint movement, the control unit 12 controls the display unit 2 so that the display size is 100%. In this manner, the display size is reduced more, as the type of the video content necessitates the viewpoint movement more, and the ratio of the video content occupied in the field of view of the occupant is reduced, so that the deviation between the motion information that enters the eyes and the motion information sensed by the body can be suppressed, and the visually induced motion sickness can be suppressed.

As illustrated in FIG. 4, the control unit 12 controls the display unit 2 in such a manner that the display size of the video content increases, as the number of playbacks increases. More specifically, in a case where the display size should be smaller than 100% in accordance with the type of the video content, the display size is enlarged to 100% in accordance with the number of playbacks. For example, at the second or later playback, the display size is enlarged by a predetermined ratio (for example, 10%) from that at the previous playback with the display size of 100% set as an upper limit. In this case, in a case where the video content is a game, the video content is displayed in the display sizes of 80% for the first time, 80% for the second time, and 100% for the third and later times.

Even though the video content is a type of video content that necessitates many viewpoint movements, by viewing the identical video content several times, the brain learns motion patterns (motion information that enters the eyes) in the video content, the confusion of the brain is suppressed, and the visually induced motion sickness hardly occurs. By adjusting the display size of the video content in accordance with the number of playbacks, it becomes possible to maximize the advantage of a large screen while suppressing the visually induced motion sickness.

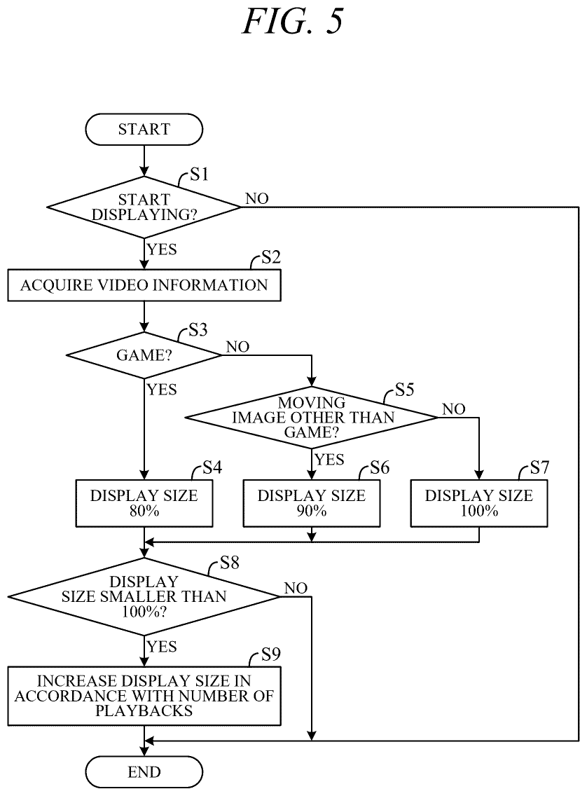

FIG. 5 is a flowchart illustrating an example of processing performed by the controller 10. The processing illustrated in this flowchart is started when the controller is activated, for example, and is repeated at a predetermined cycle until the controller is stopped. As illustrated in FIG. 5, first, in S1 (S: processing step), it is determined whether the display unit 2 starts displaying a video content. In a case where a positive determination is made in S1, the processing proceeds to S2, and in a case where a negative determination is made in S1, the processing ends. In S2, the video information that has been transmitted from the user terminal 6 is acquired.

Next, in S3, it is determined whether the type of the video content, the display of which is to be started, is a game, based on the video information acquired in S2. In a case where a positive determination is made in S3, the processing proceeds to S4, and the display size of the video content is temporarily determined to be 80%. In a case where a negative determination is made in S3, the processing proceeds to S5, and it is determined whether the type of the video content is a moving image other than the game. In a case where a positive determination is made in S5, the processing proceeds to S6, and the display size of the video content is temporarily determined to be 90%. In a case where a negative determination is made in S5, the processing proceeds to S7, and the display size of the video content is determined to be 100%.

Next, in S8, it is determined whether the display size determined (temporarily determined) in S4, S6, and S7 is smaller than 100%. In a case where a positive determination is made in S8, the processing proceeds to S9, and in a case where a negative determination is made in S8, the processing ends. In S9, the display size of this time is determined to be a display size enlarged by a predetermined ratio (for example, 10%), as compared with the previous playback with the display size of 100% set as an upper limit, based on the video information acquired in S2, in accordance with the number of playbacks of the video content, the display of which is to be started.

When starting to display the video content, by checking the type and the number of playbacks and adjusting the display size in accordance with the type, it becomes possible to suppress the visually induced motion sickness of the occupant even when viewing the video content on a large screen in a limited space in the vehicle (S1 to S7). That is, by displaying the video content that necessitates little viewpoint movement on a large screen, and reducing the display size of the video content that necessitates many viewpoint movements and that has a high possibility of causing the visually induced motion sickness, it becomes possible to suppress the visually induced motion sickness while obtaining the advantage of the large screen. In addition, by adjusting the display size in accordance with the number of playbacks, it becomes possible to maximize the advantage of the large screen while suppressing the visually induced motion sickness (S8 to S9).

According to the present embodiment, the following operations and effects are achievable.

(1) The apparatus 100 is mounted on the vehicle 1, and includes: the display unit 2, which displays a video content; the information acquisition unit 11, which acquires video information about the video content; and the control unit 12, which controls the display unit 2 to adjust a display size of the video content, based on the video information acquired by the information acquisition unit 11 (FIG. 1 and FIG. 2). By adjusting the display size of the video content in accordance with the type of the video content and the number of playbacks, it becomes possible to suppress visually induced motion sickness of an occupant, even when viewing a video content on a large screen in a limited space inside the vehicle.

(2) The video information includes information about the type of the video content, that is, whether the video content is a game, a moving image other than the game, or a still image. The control unit 12 controls the display unit 2 so that the display size of the video content in a case where the video content is the game is smaller than that in a case where the video content is the moving image other than the game, and the display size of the video content in a case where the video content is the game is smaller than that in a case where the video content is the still image (FIG. 3). When the occupant of the vehicle 1 views the video content, as the video content necessitates more viewpoint movements of the viewer (occupant), the deviation more easily occurs between the information of the motion that enters the eyes and the information of the motion sensed by the body, and the occupant is more easily prone to suffer from the visually induced motion sickness. By reducing the display size only for the video content that necessitates many viewpoint movements and that has a high possibility of causing the visually induced motion sickness, it becomes possible to appropriately suppress the visually induced motion sickness of the occupant while obtaining the advantage of the large screen.

(3) The video information includes information about the number of playbacks of the video content. The control unit 12 controls the display unit 2 to increase the display size of the video content, as the number of playbacks increases. Even for the video content of a type that necessitates many viewpoint movements, the identical video content is viewed several times, the brain learns a motion pattern in the video content, the confusion of the brain is suppressed, and the visually induced motion sickness hardly occurs. By adjusting the display size of the video content in accordance with the number of playbacks, it becomes possible to maximize the advantage of a large screen while suppressing the visually induced motion sickness.

(4) The display unit 2 includes the projector 2a, which projects the video content toward a space above the occupant of the vehicle 1 (FIG. 1). When projecting the video content toward the space above the occupant by using the projector 2a, it becomes possible to ensure a wide projection range on the ceiling 1a of the vehicle 1, and to display the video content on a large screen. In this case, it is possible for the occupant to improve the viewing experience of the video content, whereas the occupant easily suffers from the visually induced motion sickness. By adjusting the display size of the video content in accordance with the type of the video content and the number of playbacks, it becomes possible to suppress visually induced motion sickness of an occupant, even when viewing a video content on a large screen in a limited space inside the vehicle.

In the above embodiment, a specific arrangement example of the display unit 2 (the projector 2a and the screen 2b) has been described with reference to FIG. 1 and the like. However, the display unit mounted on the vehicle and displaying the video content is not limited to such a display unit. For example, the projector 2a may be disposed on a floor or the like of the vehicle 1, or may be attached to the ceiling 1a or the like.

In the above embodiment, a game, a moving image other than the game, and a still image have been given as examples of the type of the video content, in FIG. 3 and the like. However, the video information is not limited to them. Examples of the video information may include information of a genre of a game such as a shooting game or a role playing game, or a genre of a moving image such as an action movie or a healing video. In this case, the display size may be adjusted in accordance with more detailed classification based on the genre.

In the above embodiment, an example in which the information acquisition unit 11 of the controller 10 acquires the video information that has been transmitted from the user terminal 6 has been described. However, the information acquisition unit that acquires the video information is not limited to such an example. For example, the controller 10 may perform image processing to analyze the amount of motions in the video content that is being played back, and may acquire an analysis result as the video information. In this case, the number of motions in the video content that is being displayed may be analyzed every predetermined time, and the display size may be adjusted every predetermined time in accordance with the analysis result.

In the above embodiment, an example in which the display size of the video content is enlarged by 10% in accordance with the number of playbacks has been described with reference to FIG. 4 and the like. However, the adjustment of the display size of the video content based on the number of playbacks is not limited to such an example. For example, the display size may be enlarged by a different ratio between the second time and the third time. The display size may not be necessarily enlarged until a predetermined number of playbacks is reached.

The above embodiment can be combined as desired with one or more of the aforesaid modifications. The modifications can also be combined with one another.

According to the present invention, it becomes possible to suppress the visually induced motion sickness of the occupant.

Above, while the present invention has been described with reference to the preferred embodiments thereof, it will be understood, by those skilled in the art, that various changes and modifications may be made thereto without departing from the scope of the appended claims.

1. A vehicular video display apparatus, comprising:
a display unit mounted on a vehicle and configured to display video content; and
a controller including a processor and a memory coupled to the processor, wherein the controller is configured to:
acquire video information regarding the video content; and
control the display unit to adjust a display size of the video content based on the video information.

2. The vehicular video display apparatus according to claim 1, wherein the video information includes information regarding a type of the video content, the type being one of a game, a moving image other than the game, and a still image.

3. The vehicular video display apparatus according to claim 2, wherein
the controller is configured to control the display unit so that the display size in a case where the video content is the game is smaller than the display size in a case where the video content is the moving image other than the game, and the display size in a case where the video content is the game is smaller than that the display size in a case where the video content is the still image.

4. The vehicular video display apparatus according to claim 1, wherein
the video information includes information regarding a number of playbacks of the video content.

5. The vehicular video display apparatus according to claim 4, wherein
the controller is configured to control the display unit to increase the display size as the number of playbacks increases.

6. The vehicular video display apparatus according to claim 5, wherein
the controller is configured to control the display unit so that the display size increases by a predetermined ratio as the number of playbacks increases.

7. The vehicular video display apparatus according to claim 1, wherein
the display unit includes a projector configured to project the video content toward a space above an occupant of the vehicle.

8. The vehicular video display apparatus according to claim 1, wherein
the display unit includes a screen or a liquid crystal display provided on a ceiling of the vehicle.

9. The vehicular video display apparatus according to claim 1, wherein
a seat of the vehicle includes a seat cushion portion configured to support buttocks of an occupant of the vehicle, and a seat back portion configured to support a back of the occupant, wherein
the seat back portion includes a reclining mechanism capable of fixing an inclination angle with respect to the seat cushion portion at any angle, wherein
the display size of 100% is set to be suitable for the occupant to view a still image in a state in which the seat is reclined while the vehicle is stopped.

10. The vehicular video display apparatus according to claim 9, wherein
the seat includes a front seat located on a front side of the vehicle and a rear seat located behind the front seat.

11. The vehicular video display apparatus according to claim 1, wherein
the video content is selected in response to operation by an occupant of the vehicle.
